(19) United States
(12) Patent Application Publication
(10) Pub. No.: US 2015/0071026 A1
(43) Pub. Date: Mar. 12, 2015

(54) METHOD FOR EMULSION TREATMENT

(71) Applicant: EGM-Holding-International GmbH, Papenburg (DE)

(72) Inventors: Vladimier Moroz, Novotscherkassk (RU); Wilhelm Cosov, Chisinau (MD); Wofgang Gesen, Papenburg (DE); Timo Gesen, Papenburg (DE); Viktor Klauser, Papenburg (DE); Andre Linow, Rastede (DE)

(73) Assignee: EGM-Holding-International GmbH, Papenburg (DE)

(21) Appl. No.: 14/395,561

(22) PCT Filed: Apr. 18, 2013
(86) PCT No.: PCT/EP2013/058060

§ 371 Date: Oct. 20, 2014

(30) Foreign Application Priority Data
Apr. 18, 2012 (DE) 102012206399.4

(51) Int. Cl. B01F 5/06; B01F 3/08; B01F 5/12

(52) U.S. Cl. CPC B01F 5/0605; B01F 5/12; B01F 3/0807
USPC 366/165.4; 366/339

(57) ABSTRACT

A method for producing a single-phase phase-stable liquid is provided, in which, in an embodiment: in a first step, a lipophilic liquid is mixed with a hydrophilic liquid, so that a mixture of the liquids is obtained; in a second step, the static pressure of the mixture is brought below the vapor pressure of at least one of the liquids, so that cavitation bubbles occur, for example, as a result of what is known as hard cavitation; and in a third step, the cavitation bubbles are caused to implode, a single-phase phase-stable liquid being obtained.

The invention relates to a method for producing a single-phase phase-stable liquid.

On the one hand, hyperbolic funnels are known, for example from DE 10 2008 046 889, in order to set liquids in rapid rotational motion.

Furthermore, it is known, for example from U.S. Pat. No. 8,088,273 (column 5, lines 30 ff.), that hard cavitation of emulsions may lead to fundamental chemical changes.

It has hitherto not been possible, in practice, to produce phase-stable liquids from a lipophilic phase and a hydrophilic phase without emulsifiers.

The object of the present invention, therefore, is to provide a method for the production of single-phase phase-stable liquids from a lipophilic phase and a hydrophilic phase.

The object on which the invention is based is achieved, in a first embodiment, by means of a method for producing a single-phase phase-stable liquid, in which
a. in a first step, a lipophilic liquid is mixed with a hydrophilic liquid, so that a mixture of the liquids is obtained,
b. in a second step, the static pressure of the mixture is brought below the vapor pressure of at least one of the liquids, so that cavitation bubbles occur, for example, as a result of what is known as hard cavitation, and
c. in a third step, the cavitation bubbles are caused to implode, a single-phase phase-stable liquid being obtained.

In the method according to the invention, preferably, the lowering of the static pressure in the second step is brought about by the outlet of the mixture from a nozzle. As a result of the abrupt pressure drop upon exit from the nozzle, cavitation bubbles thus arise as a result of what is known as hard cavitation, since the liquid has a considerable velocity (for example, also due to the rotational motion) when it passes through the nozzle. It is assumed that chemical changes occur at the same time and, in particular, during the subsequent implosion of the cavitation bubbles.

In the method according to the invention, preferably, the mixture is set in rotational motion before the second step.

In the method according to the invention, preferably, the rotational motion of the mixture is generated by a worm with a helical tube, a hyperbolic funnel, a centrifugal pump, a tube having internal swirl-generating shapes, a turbine or by a plurality of these devices.

For example, the tube of the worm may taper. In the method according to the invention, the tapering tube of the worm preferably widens again in the throughflow direction toward the end of the worm, in which case however, especially preferably, the outlet orifice of the worm is smaller than the inlet orifice. Alternatively, the tube diameter may also be constant.

In the method according to the invention, there is preferably a convergent and, in particular, convergent/divergent nozzle.

In the method according to the invention, preferably, the mixture is first set in rotational motion by means of a centrifugal pump and, for example, the mixture is subsequently accelerated further in the worm. In particular, the mixture is subsequently preferably conducted through the tube having internal swirl-generating shapes.

In the method according to the invention, the swirl-generating shapes preferably have at least partially a helicoidal form. The tube is preferably arranged vertically. A vortex similar to a Taylor-Couette type can thereby be generated. The inside diameter of the tube preferably lies in a range of 2 to 10 cm. The length of the tube preferably lies in a range of 1 to 3 m.

In the method according to the invention, the tube of the worm preferably has at its smallest diameter a diameter of at most 30% of the diameter of the inlet.

In the method according to the invention, the liquid preferably surrounds the outlet of the nozzle. Preferably, in particular, the outlet of the nozzle is not arranged in gaseous surroundings.

After the third step c., the single-phase phase-stable liquid is preferably transferred to a reservoir.

The hydrophilic liquid is preferably water. The lipophilic liquid is preferably a fossil fuel, in particular diesel or kerosene.

The weight ratio between the hydrophilic liquid and lipophilic liquid preferably lies in a range of 0.8:1 to 1.2:1.

The method according to the invention is preferably carried out at room temperature and at atmospheric ambient pressure.

The first step a. is carried out, for example, at least partially in a charging funnel. In this charging funnel, for example, a retaining device, such as a retaining screen, is arranged at the narrow end of the funnel. Above this retaining device, for example, balls are arranged in the funnel. These balls may have, for example, a diameter in a range of 5 to 20 mm. These balls may be made, for example, from metal and, in particular, from high-grade steel. These balls have the function that the two liquids are already fully intermixed simply as a result of the charging operation.

The inner wall of the worm may, for example, be metallic and, in particular, may preferably be made from copper.

In order to optimize the throughput through the worm, a plurality of tubes and, in particular, two to three tubes may be arranged parallel to one another in a worm-like manner.

### Exemplary Embodiment

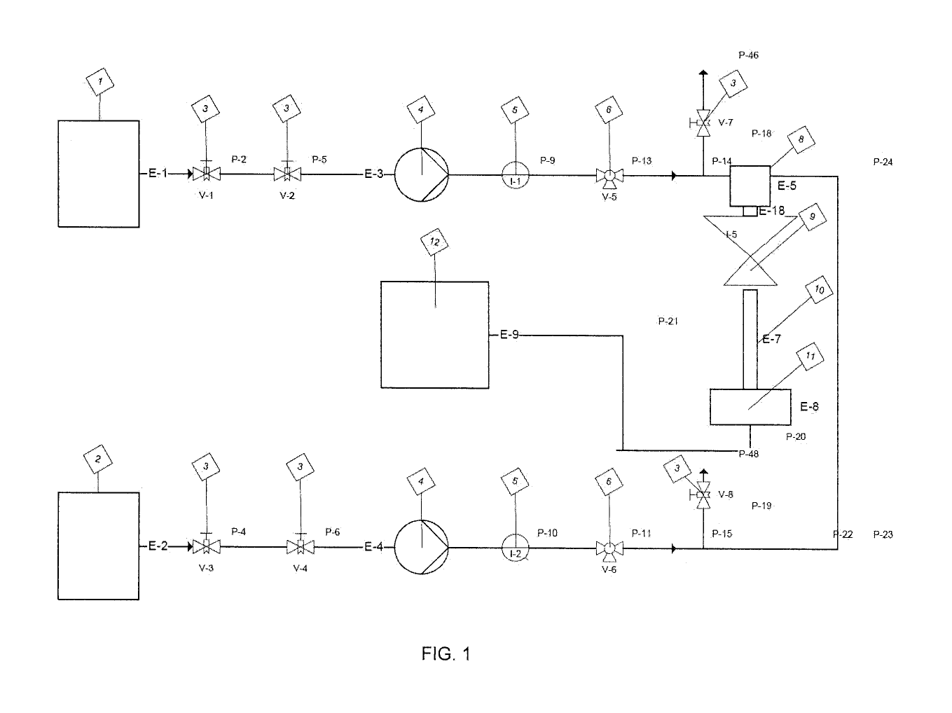

FIG. 1 shows a typical test set-up for the method according to the invention. The following concrete description of the exemplary embodiment does not restrict the scope of protection and is intended merely to illustrate the invention by way of example.

Commercially available kerosene and water were transferred in the weight ratio 1:1 under pressure via conventional delivery systems, and by way of centrifugal pump assemblies, out of the tanks 1 and 2 into a mixing chamber 8 which was configured like a vertically arranged funnel with high-grade steel balls located in it and having a diameter of 11 mm in each case. The high-grade steel balls were retained in the funnel via a retaining screen. As a result of the pressure and the balls, the liquids were emulsified with one another. Subsequently, the emulsion was conducted into a copper tube worm 9 having a uniform tube diameter of 2 cm, the tube being designed like a tapering helix which widens again toward the end of the worm. The worm 9 had an overall diameter of 20 cm at the upper end and a diameter of 5 cm at the smallest diameter. The worm 9 had at the outlet a diameter of 10 cm. Downstream of the worm 9, the emulsion was pressed through a vertically arranged tube 10 with a diameter of 7 cm and a length of 1.5 m and with a helicoidal worm-like deflecting device arranged therein (as in the case of a worm extruder in the sector of plastics technology). Thereafter, the liquid was pressed through nozzles into a container 11 having liquid. The abrupt pressure difference upon exit from the nozzles and the high velocity of the liquid (also the rotational speed) resulted in cavitation. Cavitation bubbles arose which subsequently imploded again immediately. This gave rise to a single-phase phase-stable liquid which obviously no longer contained any water and which had a very good calorific value. The liquid was subsequently transferred into a product container 12.

The calorific value of the kerosene used lay at 43.596 kJ/kg. The calorific value of the liquid obtained lay at 43.343 kJ/kg.

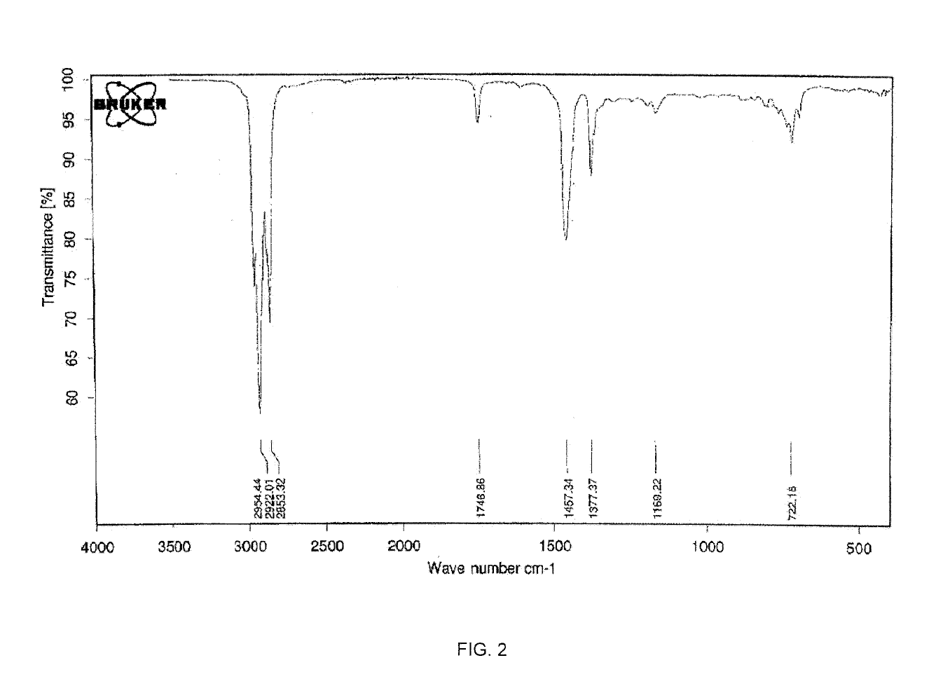

In the liquid obtained, no sign of water could be found by infrared spectroscopy (FIG. 2). The characteristic broad OH bands at about 3300 to 3400 cm⁻¹ were absent.

### LIST OF REFERENCE SYMBOLS

1 Diesel tank
2 Water tank
3 Ball-type shut-off valve
4 Centrifugal pump assembly
5 Non-return flap
6 Pressure tube measurement system
7 Three-way regulating valves
8 Mixing chamber
9 Worm
10 Tube having internal swirl-generating shapes
11 Cavitation chamber (container)
12 Product tank
13 Venting

1-10. (canceled)

11. A method for producing a single-phase phase-stable liquid, comprising:
in a first step, mixing a lipophilic liquid with a hydrophilic liquid, so that a mixture of the liquids is obtained;
in a second step, lowering the static pressure of the mixture below a vapor pressure of at least one of the liquids, so that cavitation bubbles occur; and
in a third step, causing the cavitation bubbles are caused to implode, a single-phase phase-stable liquid being obtained.

12. The method according to claim 11, wherein the lowering of the static pressure in the second step is brought about by an outlet of the mixture from a nozzle.

13. The method according to claim 11, wherein the mixture is set in rotational motion before the second step.

14. The method according to claim 13, wherein the rotational motion of the mixture is generated by at least one of: a worm with a helical tapering tube, a hyperbolic funnel, a centrifugal pump, a tube having internal swirl-generating shapes, or a turbine.

15. The method according to claim 14, wherein the tapering tube of the worm widens again in a throughflow direction toward an end of the worm.

16. The method according to claim 15, wherein an outlet orifice of the worm is smaller than an inlet orifice.

17. The method according to claim 12, wherein the nozzle includes a convergent nozzle.

18. The method according to claim 12, wherein the nozzle includes a convergent/divergent nozzle.

19. The method according to claim 14, wherein the mixture is first set in rotational motion using the centrifugal pump, and wherein the mixture is subsequently accelerated further in the worm.

20. The method according to claim 19, wherein the mixture is subsequently conducted through the tube having internal swirl-generating shapes.

21. The method according to claim 14, wherein the swirl-generating shapes have at least partially a helicoidal form.

22. The method according to claim 14, wherein the tube of the worm has at a smallest diameter a diameter of at most 30% of a diameter of an inlet.

23. The method according to claim 12, wherein the liquid surrounds the outlet of the nozzle.

24. The method according to claim 23, wherein the outlet of the nozzle is not arranged in gaseous surroundings.

25. The method according to claim 11, wherein the rotational motion of the mixture is generated by a worm with a helical tapering tube, wherein the tapering tube of the worm widens again in a throughflow direction toward an end of the worm, wherein an outlet orifice of the worm is smaller than an inlet orifice of the worm, and wherein the tube of the worm has at a smallest diameter a diameter of at most 30% of a diameter of the inlet orifice.
